(19) United States
(12) Patent Application Publication
(10) Pub. No.: US 2010/0300841 A1
(43) Pub. Date: Dec. 2, 2010

(54) GRAVITY CONVEYOR SYSTEM

(75) Inventor: Michael J. O'Brien, Richmond, MI (US)

Correspondence Address: HARNESS, DICKEY & PIERCE, P.L.C., P.O. BOX 828, BLOOMFIELD HILLS, MI, 48303, US

(73) Assignee: BLEICHERT FOERDERANLAGEN GMBH, Osterburken (DE)

(21) Appl. No.: 12/791,026

(22) Filed: Jun. 1, 2010

Related U.S. Application Data
(63) Continuation-in-part of application No. 12/472,850, filed on May 27, 2009.

(51) Int. Cl. B65G 47/74

(52) U.S. Cl. 198/563

(57) ABSTRACT

A gravity conveyor assembly includes first and second track assemblies positioned parallel to each other. Each of the track assemblies includes a body, having a slot in a first surface. A track member includes a frictional engagement portion received and frictionally engaged within the slot. A track extending portion freely extends above the first surface of the body. The track extending portion is oriented at an angle with respect to an axis oriented transverse to a ground surface such that the track extending portion has a continuous slope with respect to the ground surface. A cassette supported on the first and second track members is adapted for gravity induced rolling motion by the continuous slope. Wheels mounted to opposing sides of the cassette each have a concave perimeter surface aligned for rolling contact with the track extending portion of the track assemblies.

### CROSS-REFERENCE TO RELATED APPLICATIONS

This application is a continuation-in-part of U.S. patent application Ser. No. 12/472,850 filed on May 27, 2009. The entire disclosure of the above application is incorporated herein by reference.

### FIELD

The present disclosure relates to conveyor systems having inclined support rails that allow gravity induced motion of conveyed product carriers.

### BACKGROUND

This section provides background information related to the present disclosure which is not necessarily prior art.

Known gravity conveyor systems such as those disclosed in U.S. Pat. No. 4,359,945 to Brems et al. and U.S. Pat. No. 4,215,772 to Graham provide rail tracks that are made of thin metal material having intermittently provided support members. The spacing of the support members can allow distortion in the unsupported portions of the track and therefore allow for discontinuous slope of the track, resulting in either undesirable increased or decreased speed of transfer.

Conveyor systems such as the Brems et al. and Graham systems also do not provide for retention of the pallet except as directly supported by the rails. Moving pallets that contact each other or that contact non-moving pallets on the rail (i.e., at stop, loading, or un-loading points) can cause one or more of the pallets to jump off the rail.

### SUMMARY

This section provides a general summary of the disclosure, and is not a comprehensive disclosure of its full scope or all of its features.

According to several embodiments of the present disclosure, a gravity conveyor assembly includes a body including a female slot created in a first surface of the body. A track member includes a frictional engagement portion received in the female slot of the body and frictionally engaged within the female slot. A track extending portion freely extends above the first surface of the body. The track extending portion is oriented at an angle with respect to an axis oriented transverse to a ground surface such that the track extending portion has a continuous slope with respect to the ground surface.

According to additional embodiments, a gravity conveyor assembly includes first and second track assemblies positioned parallel to each other. Each of the track assemblies includes a body, including a female slot created in a first surface of the body. A track member includes a frictional engagement portion received in the female slot of the body and frictionally engaged within the female slot. A track extending portion freely extends above the first surface of the body. The track extending portion is oriented at an angle with respect to an axis oriented transverse to a ground surface such that the track extending portion has a continuous slope with respect to the ground surface. A cassette is supported on the first and second track members and is adapted for gravity induced rolling motion by the continuous slope.

According to further embodiments, a cassette supported on the first and second track members is adapted for gravity induced rolling motion by the continuous slope. The cassette includes opposed pairs of wheels each having a concave outer surface adapted to contact and roll on the track extending portion of each of the first and second track assemblies.

According to still further embodiments, a bracket body is fastenably connected to the body. A retention arm integrally extends from the bracket body and is axially aligned with the track extension portion. An end face of the retention arm is positioned at an overlap dimension with respect to the concave perimeter surface to preclude the wheels from being removed from the first and second track members.

According to other embodiments, a gravity conveyor assembly includes a conveyor including first and second track assemblies oppositely directed with respect to each other, the second track assembly elevated above the second track assembly, and each oriented at a downward pitch angle with respect to a ground surface. A cassette delivery device releasably engageable to the conveyor includes an upper track portion providing for gravity induced rolling motion of a cassette. The upper track portion is collinearly aligned with the second track assembly so that the cassette on the upper track portion rolls onto the second track assembly when a first retention device is displaced during engagement of the cassette delivery device to the conveyor. A lower track portion providing for gravity induced rolling motion of the cassette is collinearly aligned with the first track assembly so that the cassette when positioned on the second track assembly moves by gravity induced motion onto the lower track portion when a second retention device is displaced during engagement of the cassette delivery device.

Additional embodiments include a gravity conveyor system having a sequence queue having parallel first and second queue tracks both having a downward pitch with respect to a ground surface. A component selection track having a component shuttle cart is powered to multiple cassette receiving positions. Component group gravity conveyors are individually oriented transverse to the component selection track and individually aligned with individual ones of the cassette receiving positions of the component selection track. Wheeled cassettes each carrying a component are grouped on downwardly pitched tracks of the component group conveyors for gravity induced motion toward the component selection track. A component sequencer directs the component shuttle cart to individual ones of the cassette receiving positions to receive by gravity induced motion one of the wheeled cassettes for transport of the component carried by the one of the wheeled cassettes to the sequence queue.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side elevational view of the equipment and flow paths of a gravity conveyor system of the present disclosure;

FIG. 2 is a side elevational view of area 2 of FIG. 1 with the equipment shown reversed by 180 degrees;

FIG. 3 is the side elevational view of FIG. 2 modified to show a continuing flow path of components;

FIG. 4 is the side elevational view of FIG. 2 further modified to show the continuing flow path of components;

FIG. 5 is a top plan view of a conveyor and elevator configuration of the present disclosure;

FIG. 6 is an end elevational view of the conveyor and elevator configuration of FIG. 5;

FIG. 7 is an end elevational view of a conveyor assembly according to several embodiments of the present disclosure;

FIG. 8 is an end elevational perspective view of another embodiment of a conveyor assembly of the present disclosure;

FIG. 9 is an end elevational view of the conveyor assembly of FIG. 8;

FIG. 10 is top plan perspective view of a cassette of the present disclosure;

FIG. 11 is front elevational view of an inclined conveyor track assembly of the present disclosure;

FIG. 12 is a partial cross sectional end elevational view of another embodiment of an extruded body adapted for conveyor system support;

FIG. 13 is a top left perspective view of another embodiment of a cassette;

FIG. 14 is a front elevational view of the cassette of FIG. 13;

FIG. 15 a side elevational view of the equipment and flow paths of another gravity conveyor system of the present disclosure;

FIG. 16 is a front elevational view of a cassette delivery device of FIG. 15;

FIG. 17 is a front elevational view of the gravity conveyor system of FIG. 15 following unloading of the cassette delivery device onto a conveyor portion;

FIG. 18 is a front elevational view of the conveyor portion of FIG. 17;

FIG. 19 is a front elevational view of the cassette delivery device of FIG. 17 engaged with a loading conveyor; and

FIG. 20 is a top plan view of another gravity conveyor system of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer, or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

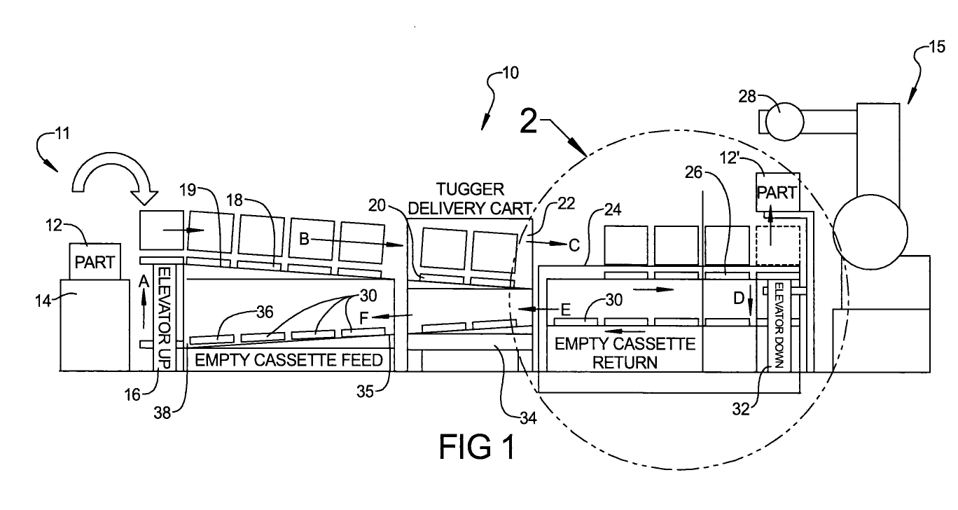

Referring to FIG. 1, a gravity conveyor system 10 of the present disclosure provides for the transportation from an assembly station 11 of a part 12 that was assembled using an assembly device 14 to an installation station 15. From the assembly device 14, the part 12 is lifted using an elevator 16 in a lift direction “A” to be supported by an individual wheeled pallet or cassette 18 which is induced to move by gravity using a gravity conveyor 19. Multiple cassettes 18 each having an individual part 12 can be moved on the gravity conveyor 19 in a first gravity induced transfer path “B” to be received by a cassette transfer device 20 of a delivery device 22. Delivery device 22 can be for example a tugger delivery cart which is capable of self propulsion from the assembly station 11 to an installation station 24. At installation station 24 each of the cassettes 18 and parts 12 are gravity offloaded for installation of each of the parts 12 using the installation station 15. Multiple ones of the cassettes 18 and parts 12 move in the second gravity induced transferred path “C” to a position where they are stopped temporarily using a cassette braking system 26. Once stopped by the braking system 26, individual ones of the parts such as part 12′ are accessed using an installation device 28 for subsequent assembly, for example into an automobile vehicle (not shown) which is being assembled. It should be understood that installation device 28 can be used to move parts 12′ for any type of installation, such as electrical components for use on electrical component circuit boards, components for assembly line installations, and the like.

Once the part 12′ has been removed from its cassette 18, the cassette re-designated as an empty cassette 30 is downwardly displaced using a second elevator 32 in an elevator transfer direction “D” so that the empty cassettes 30 can be returned to be refilled. From the installation station 24 the empty cassettes 18 gravity feed in a third gravity induced transfer path “E” to a lower receiving section of a delivery device passive transfer portion 34 of delivery device 22. From delivery device 22 the empty cassettes 30 are transferred in a fourth gravity induced transfer path “F” onto a gravity conveyor 35 which is positioned below gravity conveyor 19. Each of the empty cassettes 30 move in the fourth gravity induced transfer path “F” until they individually reach a next loading cassette position 36 defining a pickup location 38 where the empty cassette 30 is transferred in the lift direction “A” by elevator 16 to receive a new part 12. It is also envisioned in additional embodiments of the present disclosure that the delivery device 22 can be eliminated such that the cassettes 18 having parts 12 can directly transfer from gravity conveyor 19 to installation station 24.

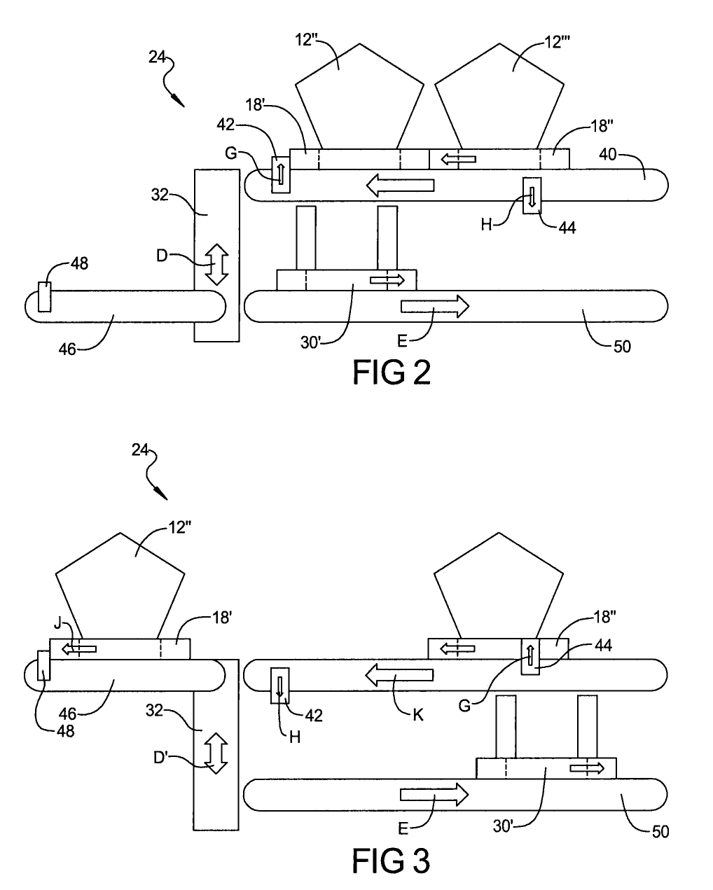

Referring to FIG. 2, a portion of installation station 24 is shown in greater detail and includes a gravity conveyor assembly 40 having a first retention member 42 which is displaceable in a retention member extension direction “G” to temporarily restrain a first cassette 18′ and a second cassette 18″ in a back-to-back configuration. At this stage first cassette 18′ carries a part 12″, and second cassette 18″ carries a part 12″′. First retention member 42 is positioned as shown to prevent further gravity induced motion of the first and second cassettes 18′, 18″, while a second retention member 44 is positioned in a retention member retraction direction “H.” Retention of first and second cassettes 18′, 18″ permits offloading of a first empty cassette 30′ from the lowered elevator support member 46 that extends from second elevator 32. Elevator support member 46 is movable upwardly or downwardly in an elevator transfer direction “D” and further includes a third retention member 48 to aid in retaining any of the empty cassettes 30 received from conveyor assembly 40. The first empty cassette 30′ rolls off of elevator support member 46 onto a second conveyor assembly 50 such that the first empty cassette 30′ is induced to roll by gravity in the third gravity induced transfer path “E.”

Referring to FIG. 3, elevator support member 46 has been displaced in an upward direction “D′” such that elevator support member 46 aligns with conveyor assembly 40. At this time, second retention member 44 is extended in the retention member extension direction “G” to physically prevent movement of second cassette 18″. Once second retention member 44 is extended, first retention member 42 is retracted in the retention member retraction direction “H” to allow gravity displacement of first cassette 18′ together with part 12″ in a cassette loading direction “J” onto elevator support member 46. During this period, first empty cassette 30′ continues its gravity induced motion in the third gravity induced transfer path “E” along second conveyor assembly 50. This motion of first empty cassette 30′ provides an open space to subsequently receive first cassette 18′ after part 12″ has been removed.

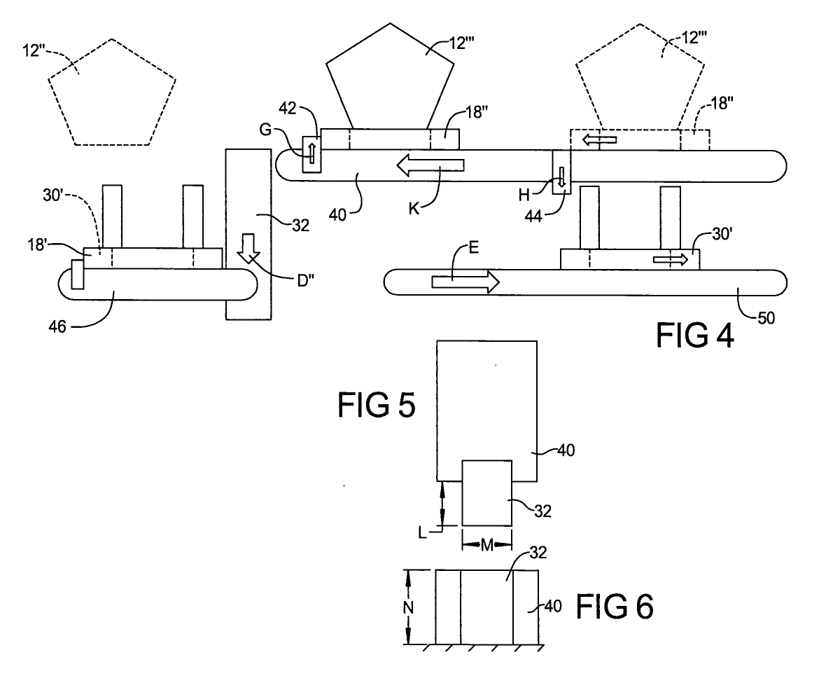

Referring to FIG. 4, after part 12″ is removed from first cassette 18′, first cassette 18′ is moved in a downward component of elevator transfer direction “D″” on elevator support member 46 until elevator support member 46 once again aligns with second conveyor assembly 50. First cassette 18′ which is now re-designated as a second empty cassette 30′ rolls onto second conveyor assembly 50 to follow first empty cassette 30′. During the downward displacement of elevator support member 46, second retention member 44 is retracted in the retention member retraction direction “H” to allow second cassette 18″ having part 12″′ to roll by gravity inducement along conveyor assembly 40 from the position shown in phantom to the restrained position created by contact with first retention member 42. First retention member 42 is displaced in the retention member extension direction “G” at the same time as second retention member 44 is displaced to receive the second cassette 18″ which rolls in a cassette transfer direction “K.”

Referring to FIG. 5, an exemplary orientation of second elevator 32 with respect to conveyor assembly 40 positions the second elevator 32 at a standoff dimension “L” from conveyor assembly 40. Elevator standoff dimension “L,” in addition to an elevator width “M” are predetermined to suit the dimensions of the cassettes 18 to be received on second elevator 32. This permits the free transfer of cassettes 18 using second elevator 32 providing clearance for the cassettes 18 to the conveyor assembly 40. It should be understood that similar configurations are provided for each of the conveyor assemblies of the present disclosure with respect to their corresponding elevators.

Referring to FIG. 6, it is desirable that second elevator 32 and conveyor assembly 40 each have a common elevator height “N.” Common elevator height “N” promotes gravity induced transfer of the cassettes from the conveyor assembly onto the second elevator 32.

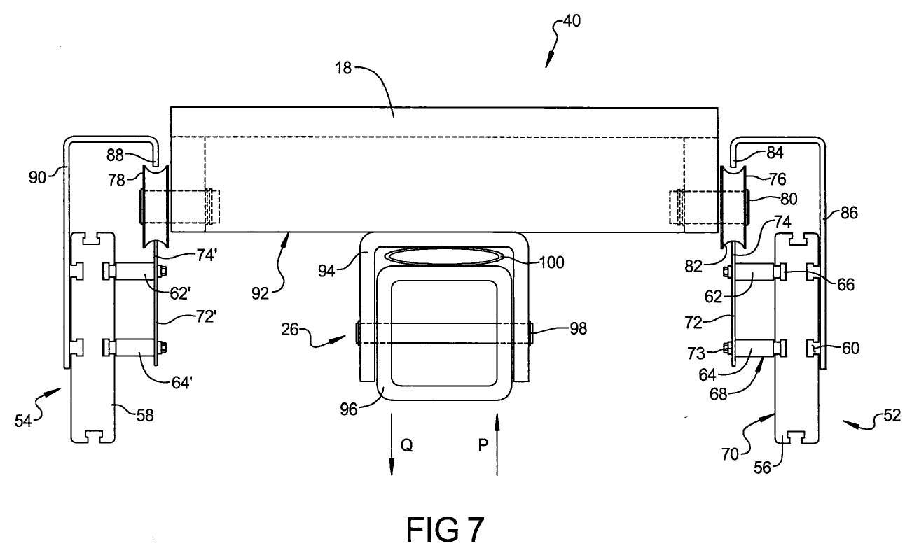

Referring to FIG. 7, according to several embodiments, conveyor assembly 40 can include parallel first and second track assemblies 52, 54. First and second track assemblies 52, 54 individually include a first extruded body 56 and a second extruded body 58, respectively. First and second extruded bodies 56, 58 can be made from multiple different materials including a metal, such as aluminum, or a plastic material. First and second extruded bodies 56, 58 can also be replaced using bodies formed from other processes such as by drawing, casting, injection-molding, or forging without varying from the scope of the present disclosure. Because each of the first and seconded extruded bodies 56, 58 and the first and second track assemblies 52, 54 are substantially mirror image configurations of each other, only first track assembly 52 will be further described herein. A plurality of elongated slots 60 are created in first extruded body 56 which are adapted to receive first and second fasteners 62, 64 such that a fastener head 66 of each of the first and second fasteners 62, 64 is slidably received in one of the elongated slots 60. A fastener body 68 extends outwardly from a body face 70 of first extruded body 56. The fastener body 68 of both first and second fasteners 62, 64 have substantially identical lengths such that a rail plate 72 made from a material such as blue steal is positioned in parallel with body face 70. A nut 73 is connected to each of the first and second fasteners 62, 64 to retain rail plate 72. A portion of rail plate 72 designated as a rail portion 74 freely extends above first fastener 62.

Each cassette 18 includes a pair of first side wheels 76, 76′ (only first side wheel 76 is shown in this view) and an opposite pair of second side wheels 78, 78′ (second side wheel 78′ is not shown in this view). Each of the first and second side wheels 76, 76′, 78, 78′ are rotatably supported on a wheel mount pin 80 which is either fastenably connected or integrally extends from cassette 18. The rail plates 72, 72′ are positioned parallel to each other for their entire length such that a concave surface 82 of each of the first and second side wheels 76, 76′, 78, 78′ is supported by one of the rail portions 74, 74′. The concave surface 82 is adapted to allow limited side-to-side motion of cassettes 18 as well as side-to-side deflection of the first and second side wheels 76, 76′, 78, 78′ during motion of cassettes 18 as they roll on the rail plates 72, 72′. A further purpose of concave surfaces 82 is to provide a self-centering feature for the cassettes as they roll on the rail portions 74, 74′.

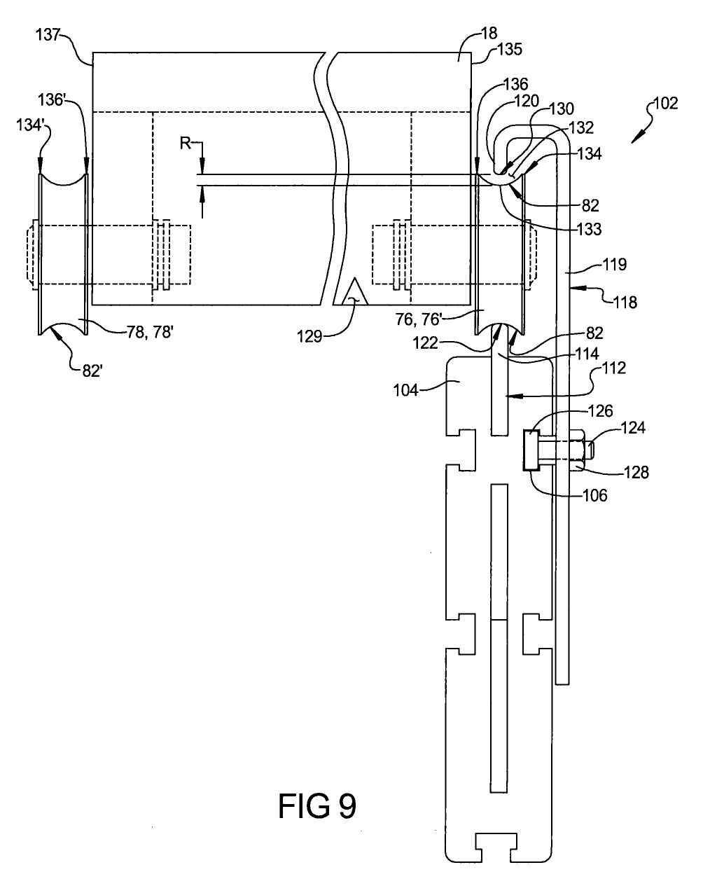

To prevent vertical displacement or removal of cassettes 18 during any of the transfer phases, a retention arm 84 of a bracket 86 fastenably connected to first extruded body 56 and a second retention arm 88 of a second bracket 90 which is fastenably connected to second extruded body 58 are positioned as shown in alignment with the concave surface of each of the first and second side wheels. The positioning and spacing of retention arms 84, 88 will be described in better detail in reference to the arrangement shown in FIG. 9.

According to several embodiments cassette braking system 26 is adapted to frictionally engage a lower surface 92 of the cassettes 18. Cassette braking system 26 can include a moving member 94 which is connected to a support member 96 using a fastener 98. Moving member 94 is movable with respect to support member 96 in either of an engagement direction “P” or a disengagement direction “Q.” An expandable member 100 can be positioned between support member 96 and moving member 94. According to several embodiments expandable member 100 is a flexible member such as an air bag which expands and contracts depending upon a pressure of a fluid introduced into the expandable member 100. As increased braking is required, a fluid such as air, water, or hydraulic fluid can be pumped into expandable member 100 to force moving member 94 upwards in the engagement direction “P” to frictionally engage the lower surface 92 of a cassette 18. To release and permit subsequent rolling motion of the cassette 18, the fluid within expandable member 100 is released, deflating expandable member 100 and allowing moving member 94 to displace in the disengagement direction “Q” until moving member 94 is no longer in frictional contact with the lower surface 92.

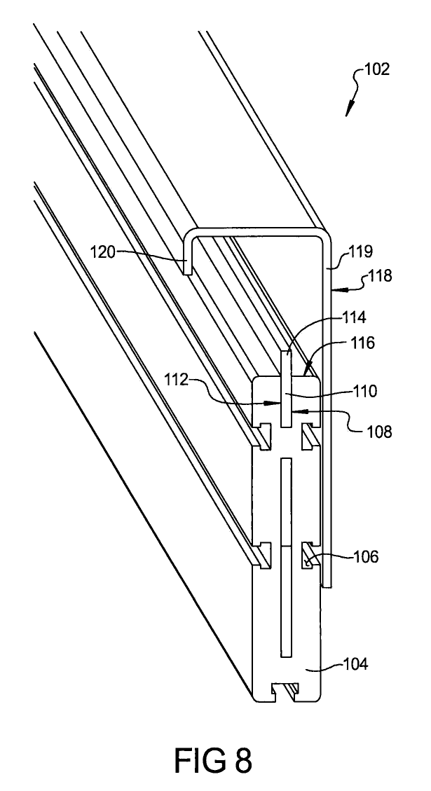

Referring to FIG. 8, according to additional embodiments of the present disclosure a third track assembly 102 provides a third extruded body 104 which includes a plurality of elongated slots 106 similar to elongated slots 60 of first and second track assemblies 52, 54. Third extruded body 104 is modified to include a female slot 108 which frictionally receives and engages a frictional engagement portion 110 of a track member 112. A track extending portion 114 of track member 112 extends above an upper surface 116 of third extruded body 104. The track extending portion 114 provides support for the various wheels of the cassettes. The embodiment shown in FIG. 8 reduces the overall quantity of parts by eliminating first and second fasteners 62, 64 compared to the embodiments shown in FIG. 7 and provides for a constant height of the track extending portion 114 by controlling the depth of the female slot 108 as well as the width of the track member 112. Material of track member 112 can be a metal, including a blue steal material, or a plastic material. A modified bracket 118 having a bracket body 119 can be fastenably connected to third extruded body 104 at individual ones of the plurality of elongated slots 106 similar to the embodiments shown in FIG. 7. Modified bracket 118 includes a retention arm 120 which can be aligned on an opposite side of third extruded body 104 with respect to bracket body 119, or can be axially aligned with a central axis of track extending portion 114 as shown in reference to FIG. 9. The third extruded body 104, as well as the other extruded bodies of the present disclosure, can be bent to a minimum radius to provide for track curvature. The extruded bodies can be bent before or after insertion of the track member.

Referring to FIG. 9, third track assembly 102 is shown as it interfaces with first side wheel 76 and second side wheel 78 of cassette 18. Track extending portion 114 can have a rounded surface 122 which corresponds to a geometry of the concave surface 82 of the first and second side wheels 76, 78. Use of rounded surface 122 reduces frictional wear on concave surface 82 compared to having sharp corners at the end of track extending portion 114. An exemplary fastener 124 is shown which can be used to fasten bracket body 119 of modified bracket 118 to third extruded body 104. Fastener 124 includes a fastener head 126 slidably received in one of the elongated slots 106. A nut 128 can be applied to a threaded end of fastener 124 to engage bracket body 119 against an outer face of third extruded body 104. A slot such as a triangular-shaped or other geometrically shaped alignment slot 129 can be provided on a forward directed face of the cassettes 18. Alignment slot 129 can be used in combination with a similarly shaped male member provided between pairs of the extruded bodies to axially align each cassette 18 for more accurate location of the cassette 18 during loading or offloading operations.

According to several embodiments retention arm 120 of modified bracket 118 is aligned with track extending portion 114 and includes an arm and a face 130 which is positioned within a cavity 132 defined by concave surface 82 between a base point 133 and an outer perimeter edge 134 and an inner perimeter edge 136 of first side wheel 76. An overlap dimension “R” of arm end face 130 within the cavity 132 is controlled to prevent the first and second side wheels 76, 78 from disengaging from track extending portion 114. Overlap dimension “R” can be controlled by adjusting a vertical position of modified bracket 118 using fasteners 124.

According to several embodiments, each cassette 18 includes at least first and second wheels 76, 76′, 78, 78′ also configured as pairs of wheels individually mounted to opposing sides 135, 137 of the cassette 18. Each of the wheels 76, 76′, 78, 78′ have a perimeter concave surface 82, 82′ positioned between an inner perimeter edge 136, 136′ and an outer perimeter edge 134, 134′. The perimeter concave surface 82, 82′ of each of the wheels 76, 76′, 78, 78′ is aligned for rolling contact with the track extending portion 114 of individual ones of the first and second track assemblies.

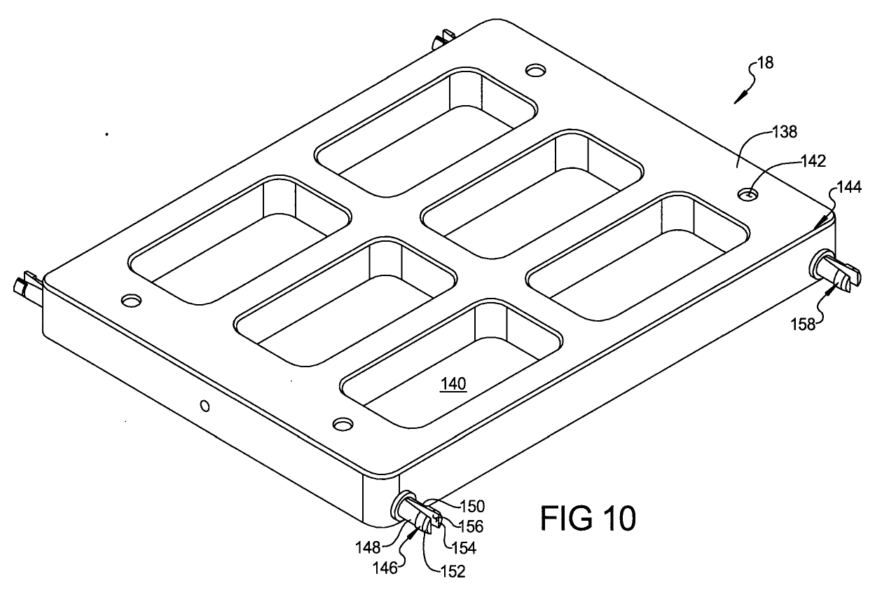

Referring to FIG. 10, an exemplary cassette 18 can be made from a molded plastic material, a cast metal material, or manufactured from a metal material including a cassette body 138. Cassette body 138 can include one or more weight reduction cavities 140 and at least one and preferably a plurality of object connection support apertures 142. Object connection support apertures 142 can be used to connect restraints to provide containment boundaries for the parts that are normally carried by cassettes 18. The attached restraints can vary in geometry depending upon the geometry of the parts 12 to be carried. Cassette body 138 can further include a plurality of wheel mount pins 146. Wheel mount pins 146 can be fastened or otherwise mechanically connected to side walls of cassette body 138, or can also be integrally connected when the cassette 18 is molded or cast such that the wheel mount pins 146 are molded or cast of the same material and at the same time that cassette body 138 is molded or cast, defining an integral, homogeneous connection between the plurality of wheel mount pins 146 and cassette body 138. Each of the wheel mount pins 146 can further include a first pin portion 148 and a second pin portion 150 which are elastically deflectable toward and away from each other to allow a wheel to be mounted on each of the wheel mount pins. The mounted wheels are retained by contact with first and second flared flanges 152, 154 individually provided with one of the first and second pin portions 148, 150. A clearance space 156 is provided in the as molded or as constructed configuration of each of he wheel mount pins 146.

Referring to FIG. 10 and again to FIGS. 7 and 9, first and second flared flanges 152, 154 are oriented opposite to each other and extend radially outward from their respective first and second pin portions 148, 150. As one of the first or second side wheels 76, 78 is slidably engaged over the wheel mount pins 146, the first and second flared flanges 152, 154 contact a sleeve of the wheel which elastically deflects the first and second pin portions 148, 150 toward each other. Once the wheel is pressed past the first and second flared flanges 152, 154, the first and second pin portions 148, 150 elastically expand outwardly such that the first and second flared flanges 152, 154 provide a positive stop to prevent removal of the individual wheel unless the first and second pin portions 148, 150 are manually deflected toward each other. A substantially flat back face 158 is provided with each of the first and second flared flanges 152, 154 which provides a positive stop to prevent the removal of the wheels under normal operating conditions.

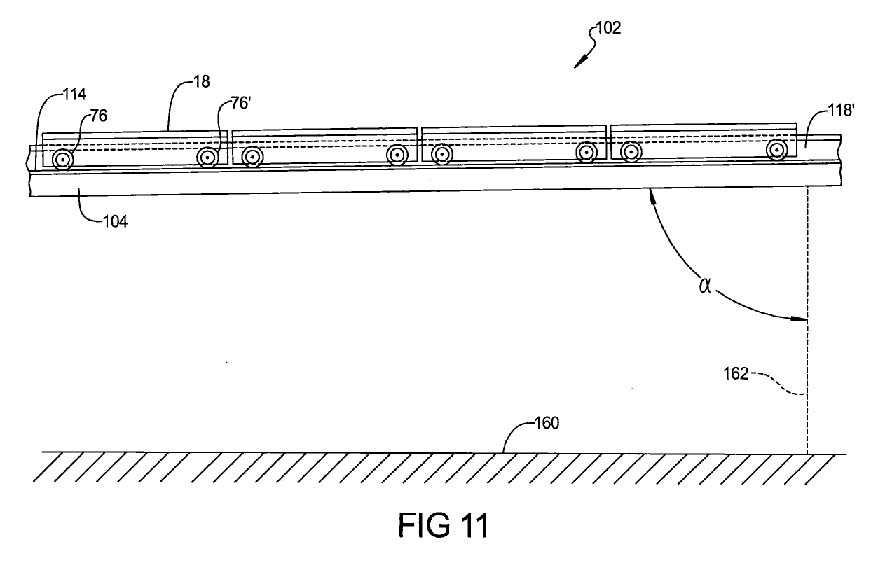

Referring to FIG. 11 and again to FIG. 9, track assemblies of the present disclosure such as third track assembly 102 shown have a continuous slope or pitch with respect to a ground surface 160 to allow for gravity transport of the plurality of cassettes 18. According to several embodiments the amount of slope is measured as an angle alpha (α) from an upper surface of the track extending portion 114 such as upper surface 116 together with track member 112 as it extends outwardly of third extruded body 104 with respect to a reference axis 162. Reference axis 162 is oriented transverse to ground surface 160. According to several embodiments angle α can range from approximately 98 degrees to approximately 99.75 degrees inclusive and preferably ranges from approximately 99 degrees to approximately 99.5 degrees inclusive. The slope of track extending portion 114 created by the use of angle a allows cassettes 18 to start rolling against a static friction of the wheels and bearings and also limits the rolling speed of the cassettes 18 to reduce a collision force between standing and moving cassettes 18.

With reference to FIGS. 8 and 11, a gravity conveyor system or assembly 102 can therefore include an extruded body 104 including a female slot 108 created in an upper or first surface 116 of the body 104. A track member 112 includes a frictional engagement portion 110 received in the female slot 108 of the body 104 and frictionally engaged within the female slot 108. A track extending portion 114 freely extends above the first surface 116 of the body 104. The track extending portion 114 is oriented at an angle α with respect to an axis 162 oriented transverse to a ground surface 160 such that the track extending portion 114 has a continuous slope (defined as 90 degrees minus angle α) with respect to the ground surface 160.

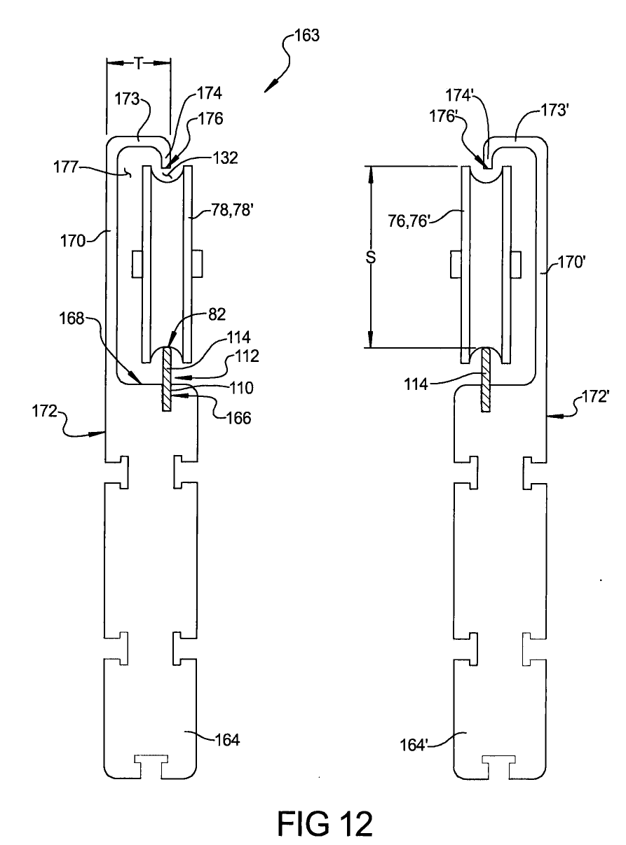

Referring to FIG. 12 and again to FIG. 8, according to additional embodiments of the present disclosure a gravity conveyor support system 163 can include a fourth extruded body 164, 164′ having a female slot 166 which frictionally receives and engages frictional engagement portion 110 of track member 112 similar to third extruded body 104. The track extending portion 114 of track member 112 extends above an upper surface 168 of fourth extruded body 164, 164′. Fourth extruded body 164, 164′ is further modified to integrally include a bracket body 170 extending from upper surface 168. Bracket body 170 can be substantially parallel to an outer surface 172 of fourth extruded body 164, 164′. An integral body end 173 can be oriented substantially perpendicular to bracket body 170 and can include an integrally connected retention arm 174 oriented substantially parallel to bracket body 170 having a face 176 positioned within the cavity 132 of second side wheels 78, 78′ (or alternately first side wheels 76, 76′). The lengths of the bracket body 170 and body end 172 are predetermined to position face 176 within cavity 132 to horizontally restrain the second side wheels 78, 78′ or alternately the first side wheels 76, 76′ and to coaxially align the retention arm 174 with the track extending portion 114 of the track member 112.

The embodiment of fourth extruded body 164, 164′ shown in FIG. 12 further reduces the overall quantity of parts compared to third extruded body 104 by integrally or homogeneously extending the bracket body 170, 170′ during extrusion of fourth extruded body 164, 164′, which eliminates fasteners and fastener receiving apertures required to attach bracket body 170, 170′ compared to third extruded body 104. The upper surface 168, bracket body 170, body end 173, and track member 112 together define a partially open wheel receiving cavity 177 adapted to receive the first or second side wheels 76, 76′, 78, 78′. A clearance “S” between face 176 and track member 112 can be predetermined to be less than an outside diameter of first and second side wheels 76, 76′, 78, 78′ to retain a portion of first and second side wheels 76, 76′, 78, 78′ within wheel receiving cavity 177. The cassette having first and second side wheels 76, 76′, 78, 78′ can therefore be restricted to end loading in a direction toward or away from the viewer with respect to FIG. 12.

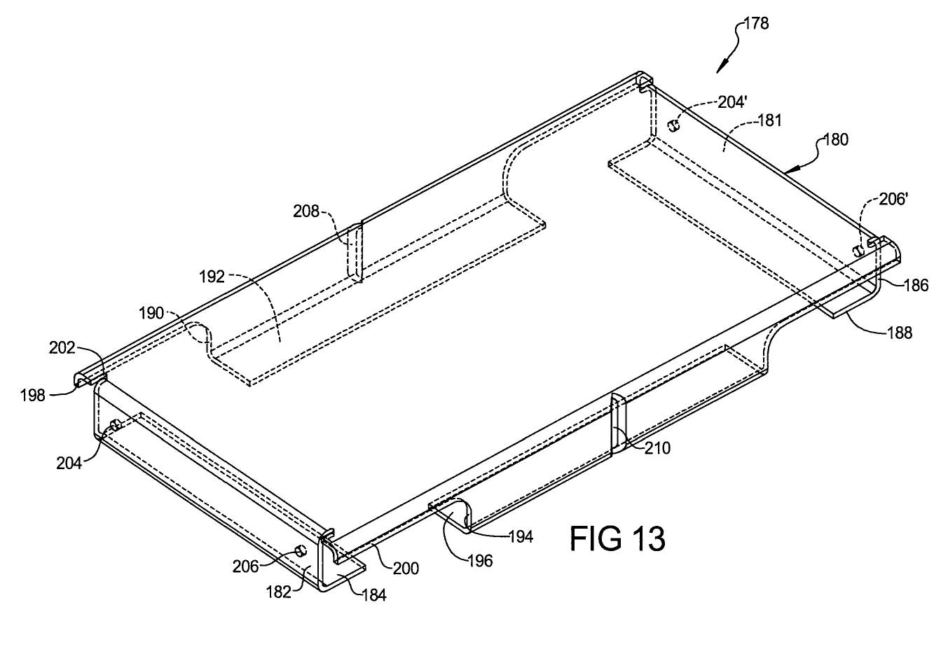

Referring to FIG. 13, a cassette 178 (shown without first or second side wheels 76, 76′, 78, 78′ for clarity) can be created from a single sheet or plate of a metal such as steel or aluminum which is bent or otherwise formed to create additional features. A cassette body 180 can include a support plate 181 having a first end wall 182 bent or formed approximately transversely thereto. A first flange 184 is oriented approximately transverse to first end wall 182 and extends inwardly. An opposed second end wall 186 is similarly bent or formed approximately transverse to support plate 181 and parallel to first end wall 182. A second flange 188 bent or formed from second end wall 186 is oriented approximately coplanar with respect to support plate 181 and extends inwardly and toward first flange 184. A third end wall 190 is bent or formed transverse to support plate 181, and is longitudinally oriented transverse to both first and second end walls 182, 186. A third flange 192 is bent or formed transverse to third end wall 190 and is directed inwardly. A fourth end wall 194 is opposed and oriented parallel with third end wall 190 similarly includes a fourth flange 196 directed inwardly and toward third flange 192. Each of the first, second, third, and fourth flanges 184, 188, 192, and 196 can be oriented coplanar to each other.

With further reference to FIG. 13 and again to FIG. 9, first and opposed second reduced bends 198, 200 reinforce the corners of cassette 178 while removing material to allow for clearance between first, second, third, and fourth flanges 184, 188, 192, 196. A clearance notch 202 is also commonly used to create each of the first, second, third, and fourth end walls 182, 186, 190, and 194. Apertures 204, 204′, 206, 206′ in first and second end walls 182, 186 are adapted for rotationally mounting the first and second side wheels 76, 76′, 78, 78′. Opposed first and second indentations 208, 210 can be formed for example by punching or swaging material of third and fourth end walls 190, 194. First and second indentations 208, 210 stiffen the third and fourth end walls 190, 194 and can further function similar to geometrically shaped alignment slot 129 described in reference to FIG. 9.

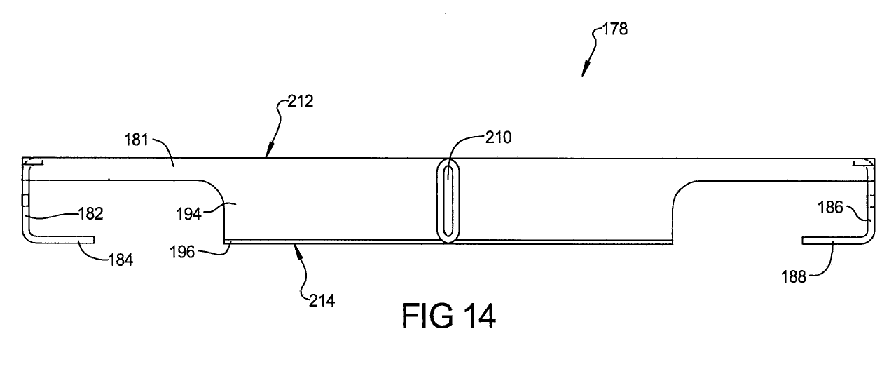

Referring to FIG. 14 and again to FIG. 7, support plate 181 defines a substantially planar surface 212 to support products carried by cassette 178. Each of the first flange 184, second flange 188, and third and fourth flanges 192, 196 (third flange 192 is not clearly visible in this view) are oriented coplanar to each other and together define a lower planar surface 214, which is parallel to planar surface 212. The portion of lower planar surface 214 defined by third and fourth flanges 192, 196 can be used as a frictional braking surface for braking cassette 178, similar to lower surface 92 described in reference to braking system 26. According to other embodiments, first and second flanges 184, 188 are not required to be coplanar with third and fourth flanges 192, 196.

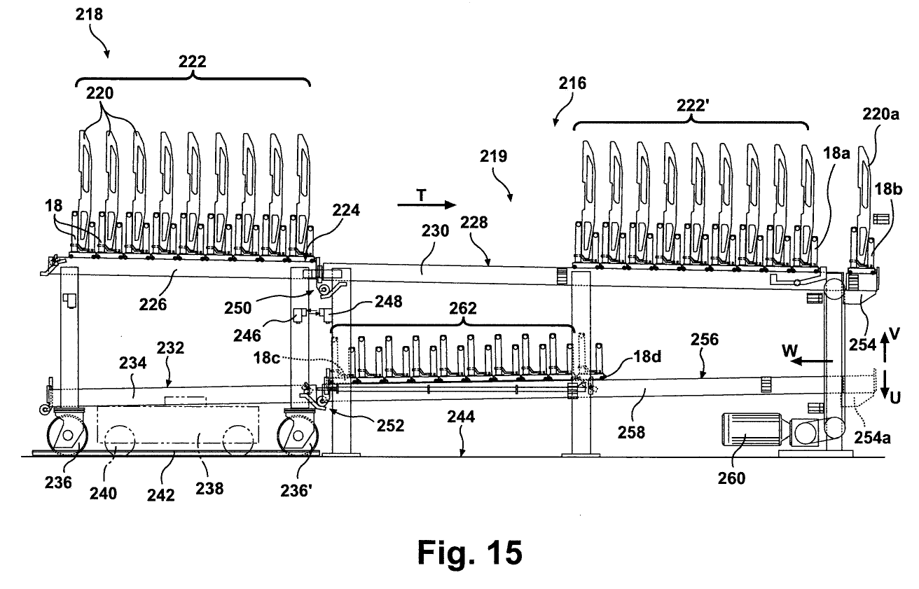

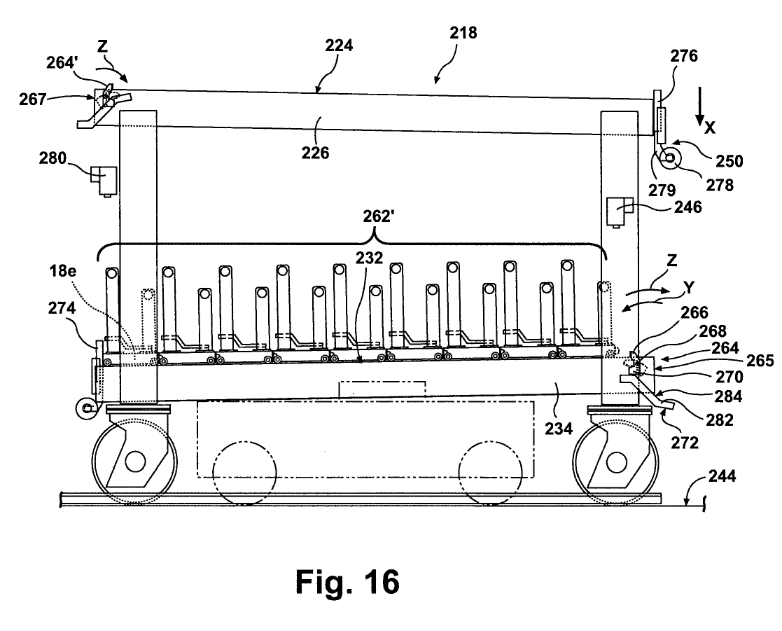

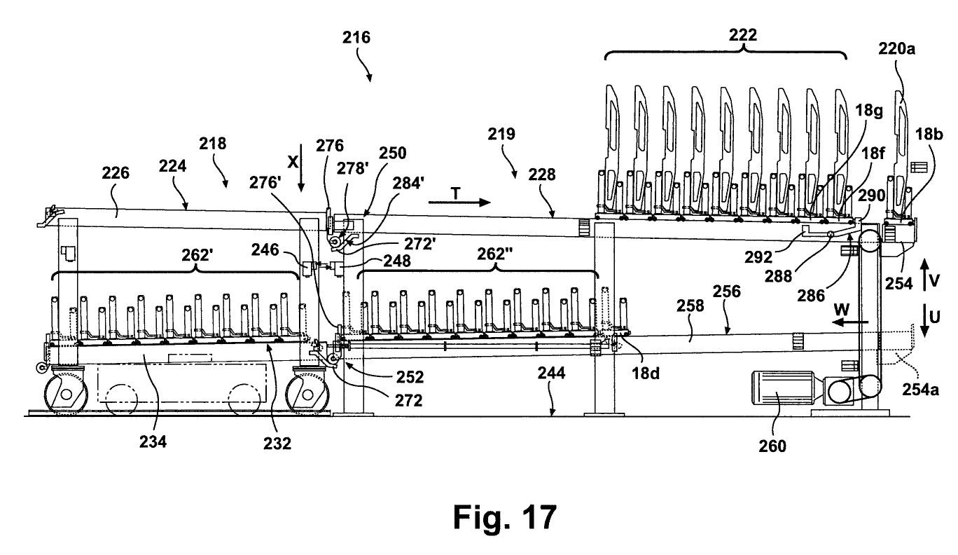

Referring to FIG. 15, a gravity conveyor system 216 according to additional embodiments includes a cassette delivery device 218 which can be manually or automatically moved into an engaged position with a conveyor 219. A plurality of products 220 supported individually by a plurality of cassettes 18 are shown in their transport position in a full cassette group 222 supported on an upper track assembly 224 of an upper track support structure 226 of cassette delivery device 218. Full cassette group 222 can be offloaded by gravity induced motion onto a second upper track assembly 228 supported by a second upper track support structure 230 of conveyor 219 in a cassette offload direction “T.” Cassette delivery device 218 also includes a lower track assembly 232 supported on a lower track support structure 234 which can receive empty cassettes 18 as will be further described in reference to FIGS. 16 and 17.

Cassette delivery device 218 includes a plurality of transport wheels 236 to allow for manual displacement of cassette delivery device 218. If automatic transfer of cassette delivery device 218 is desired, an automatic cart transfer device 238 can be provided which contacts lower track support structure 234 and includes its own set of transfer device wheels 240 adapted to follow a guide device 242 so that cassette delivery device 218 can be automatically delivered for releasable engagement to conveyor 219. Transport wheels 236 and transfer device wheels 240 are intended for transfer with respect to a ground surface 244, which also supports conveyor 219.

When cassette delivery device 218 is engaged with conveyor 219 and ready to deliver full cassette group 222, or to receive empty cassettes, data representative of the products 220 carried, availability of a space to receive full cassette group 222 on second upper track assembly 228, or the readiness of cassette delivery device 218 to be disconnected from conveyor 219 are wirelessly transmitted to and from a first optical data device 246 connected to cassette delivery device 218 and a second optical data device 248 connected to conveyor 219. A first cam stop/release device 250 is provided with cassette delivery device 218 which when triggered by contact with conveyor 219 releases the full cassette group 222 onto second upper track assembly 228 of conveyor 219. Similarly, a second cam stop/release device 252 connected to conveyor 219 also trips when cassette delivery device 218 contacts conveyor 219 such that empty cassettes can be gravity transferred onto lower track assembly 232 of cassette delivery device 218.

At an opposite end of conveyor 219 from second cam stop/release device 252, an elevator device 254 is movably connected. Elevator device 254 is shown in its upper receiving position to receive individual cassettes and the product 220 carried by the cassette for powered transfer in a downward direction “U” to a position represented as elevator device 254a. When product 220 is offloaded, the cassette is defined as an empty cassette and is released from elevator device 254a, elevator device 254 then returns to the upper receiving position in an upward direction “V” to receive a next cassette and product 220. Empty cassettes moving by gravity induced motion off elevator device 254a move in an empty cassette return direction “W” onto a second lower track assembly 256 which is supported by a second lower track support structure 258 of conveyor 219. Elevator device 254 is translated using a power unit 260 such as an electric or air operated motor.

Empty cassettes which move onto second lower track assembly 256 travel in the empty cassette return direction “W” to an end of second lower track assembly 256 represented by the position of empty cassette 18c. A quantity of empty cassettes which can be carried on lower track assembly 232 of cassette delivery device 218 define an empty cassette group 262. When a predetermined quantity of empty cassettes defining empty cassette group 262 is received and is discharged from second lower track assembly 256 onto lower track assembly 232, cassette delivery device 218 is disengaged from conveyor 219. During offload of empty cassette group 262, a next empty cassette 18d (and any subsequently received empty cassettes) is stopped at the position shown so that only the empty cassette group 262 will feed by gravity induced motion onto lower track assembly 232. As previously noted, second cam stop/release device 252 is tripped when contact is made between cassette delivery device 218 and conveyor 219, which releases empty cassette group 262 for gravity transfer onto lower track assembly 232, while the next empty cassette identified as cassette 18d and others behind it will be retained in the position shown during the offload of empty cassette group 262.

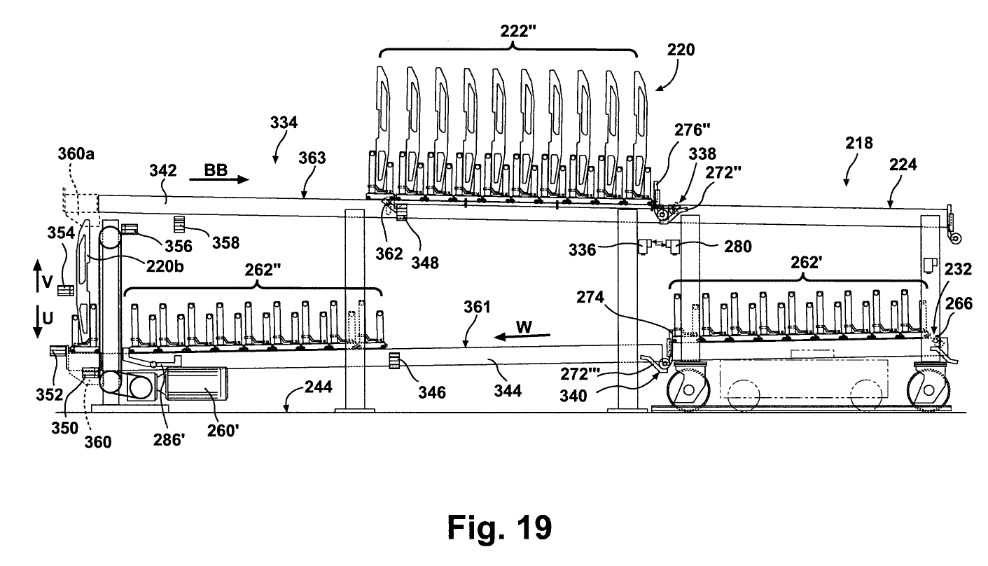

Referring to FIG. 16, cassette delivery device 218 is subsequently shown after release of full cassette group 222 and following receipt of the empty cassette group now designated as empty cassette group 262′. An anti-backup latching device 264 is located proximate to a cassette receiving end 265 of lower track assembly 232. As each empty cassette rolls onto lower track assembly 232, the empty cassette rotates anti-backup latching device 264 about a first rotation arc “Y” such that a cam arm 266 is rotatably displaced about a cam pin 268. A cam return mass 270 is oppositely positioned about cam pin 268 with respect to cam arm 266. Cam return mass 270 has a greater weight than cam arm 166, such that cam return mass 270 returns cam arm 266 to its upright position shown after each cassette passes cam arm 266 by rotation in a second rotation arc “Z” oppositely directed with respect to first rotation arc “Y.” Cam arm 266 can only rotate from a vertical position about first rotation arc “Y,” therefore cassettes cannot roll in a reverse direction off of lower track assembly 232. A second anti-backup latching device 264′ is also provided proximate to a loading end 267 of upper track assembly 224. Second anti-backup latching device 264′ functions similarly to but in an opposite direction with respect to anti-backup latching device 264 of lower track assembly 232. Second anti-backup latching device 264′ rotates in the second rotation arc “Z” as product supporting cassettes are loaded onto upper track assembly 224 which will be described in better detail in reference to FIG. 19.

A contact arm 272 is connected to lower track support structure 234 proximate to first anti-backup latching device 264. Oppositely positioned with respect to contact arm 272 and first anti-backup latching device 264 is a first retention/release pin 274 which is positioned in a vertically upright orientation as empty cassette group 262′ is loaded onto lower track assembly 232. The upright position of first retention/release pin 274 provides a positive stop for empty cassette 18e and the remaining empty cassettes of empty cassette group 262′. A second retention/release pin 276 is shown in a vertically extended upright position at the discharge end of upper track support structure 226. Second retention/release pin 276 can be retracted in a release direction “X” when a contact wheel 278 connected by a connecting arm 279 to first cam/stop release device 250 deflects by contact with a similar contact arm as contact arm 272 (provided with conveyor 219 and which will be described in reference to FIG. 17). The contact arm 272 and each of its equivalent members include an arm portion 282 having a contact surface 284 angularly disposed with respect to ground surface 244 which cause deflection of contact wheel(s) 278. Positioned at an opposite end of cassette delivery device 218 with respect to first optical data device 246 is a third optical data device 280, which functions similarly to first and second optical data devices 246, 248 previously described.

Referring to FIG. 17, and with further reference to FIG. 15, full cassette group 222 is shown after release from upper track assembly 224 and transfer in the cassette offload direction “T” onto second upper track assembly 228. Release of the full cassette group 222 is accomplished when a contact wheel 278′ of first cam stop/release device 250 contacts the contact arm 272′ connected to structure of conveyor 219. Contact wheel 278′ moves or deflects on contact surface 284′ which pulls the second retention/release pin 276 downward in the pin release direction “X.”

The cassettes of full cassette group 222 travel in the cassette offload direction “T” to a far end of second upper track assembly 228 where one of the cassettes, identified as cassette 18f, is stopped by a rocking stop/release member 286. Rocking stop/release member 286 pivots about a pivot axis 288 such that a first stop leg 290 is positioned in the raised position shown to provide a positive stop for cassette 18f. An oppositely positioned second stop leg 292 of rocking stop/release member 286 pivots upward to stop a subsequent cassette, identified as cassette 18g, when product 220 is offloaded from cassette 18f. A cassette 18b is shown after it is individually allowed to move off second upper track assembly 228 onto elevator device 254. Cassette 18b can thereafter be lowered and product 220a can be individually removed. After the now empty cassette moves by gravity induced motion onto second lower track assembly 256 in the empty cassette return direction “W,” elevator device 254 returns in the upward direction “V” to receive the next cassette identified as cassette 18f.

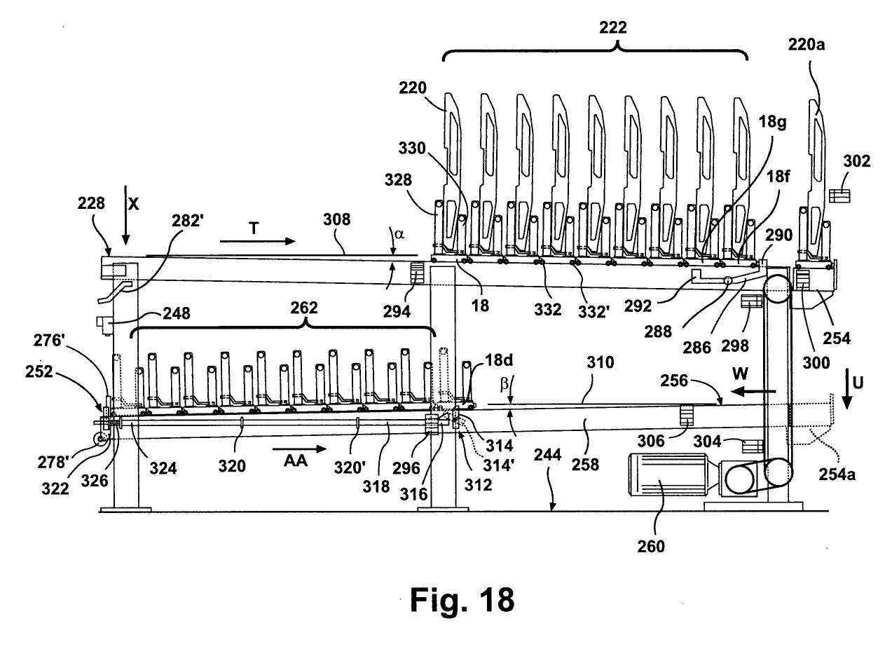

When engagement between cassette delivery device 218 and conveyor 219 occurs, second cam stop/release device 252 contacts contact arm 272 of cassette delivery device 218 which pulls second retention/release pin 276′ downward in the pin release direction “X” which allows the empty cassette group 262 to move onto lower track assembly 232 by gravity induced motion. An empty cassette identified as empty cassette 18d is retained in the position shown until cassette delivery device 218 is again disengaged from conveyor 219 at which time second retention/release pin 276′ will move in the upward direction “V” allowing a new empty cassette group 262′ to be created. The position of second empty cassette group 262′ is therefore provided for information only as this configuration will not occur until disengagement of cassette delivery device 218 shown in greater detail with respect to FIG. 18.

Referring to FIG. 18, to sequence the individual operations required to offload individual products 220a using elevator device 254, a plurality of switches including first, second, third, fourth, fifth, sixth, and seventh switches 294, 296, 298, 300, 302, 304, and 306 are provided. Any or all of the switches 294 through 306 can have an input or output signal transferred via second optical data device 248.

With reference to FIGS. 15 and 18, the unloading process takes place as follows. Cassette delivery device 218 is waiting having upper track assembly 224 loaded with full cassette group 222 and lower track assembly 232 empty. Cassette delivery device 218 receives a call signal from conveyor 219. The call signal occurs when first switch 294 on conveyor 219 opens and when second switch 296 is closed. This indicates that empty cassettes are waiting for pickup on lower track assembly 232 and second upper track assembly 228 has space for the full cassette group 222 arriving. The call signal is transmitted via the first and second optical data devices 246, 248.

Gravity conveyance of full cassette group 222 can occur in cassette offload direction “T” onto second upper track assembly 228 because second upper track assembly 228 is oriented for its entire length at a downward angle α with respect to a first reference plane 308. Similarly, second lower track assembly 256 is oppositely oriented at a downward slope or angle β with respect to a second reference plane 310 which is parallel to ground surface 244 similar to first reference plane 308. As previously noted, angle a is substantially equal to angle β, and both equal approximately one degree of downward pitch.

A separating stop 312 is connected to second lower track support structure 258. Separating stop 312 includes a stop arm 314 which can be positioned in the vertical orientation shown to block gravity movement of cassette 18d, or can be rotated in a counter-clockwise direction as viewed in reference to FIG. 18 by contact from a drive end 316 of a separating stop link 318. Separating stop link 318 is slidably supported to second lower track support structure 258 using at least one and according to several embodiments a plurality of support brackets such as support brackets 320, 320′. A force transfer link 322 which is provided with second cam stop/release device 252 displaces as contact wheel 278′ displaces during engagement with cassette delivery device 218 as previously noted. When second cam stop/release device 252 is positioned in the disengaged position as shown in FIG. 18, second retention/release pin 276′ is vertically extended to retain the cassettes of empty cassette group 262.

At this same time, stop arm 314 of separating stop 312 is rotated to the position shown as stop arm 314′ such that empty cassettes can fill the space required for empty cassette group 262 up to, but not including, the cassette identified as cassette 18d. When contact wheel 278′ is displaced, second retention/release pin 276′ is pulled downward in the pin release direction “X” while simultaneously force transfer link 322 displaces a contact end 324 of separating stop link 318 in a displacement direction “AA.” This displacement of separating stop link 318 causes drive end 316 to displace stop arm 314 to its vertically upright position shown. The combination of downward displacement of second retention/release pin 276′ and the upward rotation of stop arm 314 permits empty cassette group 262 to roll off second lower track assembly 256 while cassette 18d is retained by contact with stop arm 314. A biasing element 326 is compressed when separating stop link 318 is displaced in the displacement direction “AA” and returns the separating stop link 318 in an opposite direction when contact wheel 278′ returns to the position shown in FIG. 18 which is the disengaged position with respect to cassette delivery device 218.

First through seventh switches 294 through 306 operate as follows during the unloading operation of cassettes. Elevator device 254 is initially in the raised position with third switch 298 closed. When full cassette group 222 arrives on second upper track assembly 228, the fourth and fifth switches 300, 302 are closed. When fourth and fifth switches 300, 302 close, power unit 260 energizes and moves the elevator device 254 to its lower position in alignment with lower track assembly 256. Power unit 260 stops or de-energizes when the sixth switch 304 closes as elevator device 254 reaches the lower position shown as elevator device 254a. An operator (not shown) then unloads product 220a from cassette 18b. When product 220a is removed from cassette 18b, fifth switch 302 opens. At this time the now empty cassette 18b will exit via gravity induced motion onto lower track assembly 256. Once empty cassette 18b has cleared the elevator deck, fourth switch 300 opens and seventh switch 306 closes. When seventh switch 306 closes, power unit 260 restarts and advances the elevator device 254 back to the upper level position. When elevator device 254 reaches the upper position, third switch 298 closes and elevator power unit 260 is de-energized.

Referring to FIG. 19, when upper track assembly 224 is emptied of its full cassettes and an empty cassette group such as empty cassette group 262 has been loaded onto lower track assembly 232, both cam arm 266 and first retention/release pin 274 will be oriented in their upright positions so that cassette delivery device 218 can be moved without displacement of empty cassette group 262′. At this time, cassette delivery device 218 disengages from the conveyor 219 and travels to a remotely located loading conveyor 334 and engages with the loading conveyor 334 by engaging each of a third cam/stop release device 338 and a fourth cam/stop release device 340. Third and fourth cam/stop release devices 338, 340 function similarly to first and second cam stop/release devices 250, 252 as previously described. Electronic data from cassette delivery device 218 can be transferred to and/or from loading conveyor 334 by wireless data transfer to and/or from second optical data device 248 and a fourth optical data device 336 which is connected to loading conveyor 334. Loading conveyor 334 can include each of a third upper track support structure 342 and a third lower track support structure 344. A plurality of switches are also provided with loading conveyor 334 which include each of an eighth, ninth, tenth, eleventh, twelfth, thirteenth, and fourteenth switches 346, 348, 350, 352, 354, 356, and 358. A second elevator device 360 is similar to the previously described elevator device 254, but functions to lift the now empty cassettes from third lower track support structure 344 to the third upper track support structure 342 where the empty cassettes can be reloaded with product 220.

When cassette delivery device 218 engages with loading conveyor 334, the first retention/release pin 274 of fourth cam/stop release device 340 displaces downwardly allowing the empty cassettes of empty cassette group 262′ to gravity transfer onto a third lower track assembly 361 supported by third lower track support structure 344. The empty cassettes of empty cassette group 262′ move by gravity induced motion in the empty cassette return direction “W” to a far end of third lower track support structure 344 where they are stopped using a second rocking stop/release member 286′ which functions similar to first rocking stop/release member 286 previously described. Individual empty cassettes are then transferred onto second elevator device 360 where a product 220b is loaded prior to moving the cassette in the upward direction “V” using second elevator device 360 to the upward transport position identified as second elevator device 360a.

Once the reloaded cassettes reach the elevated position of second elevator device 360a, they are released to transfer by gravity in a transfer direction “BB” and are temporarily held in position by a vertically disposed second retention/release pin 276″ which forms a portion of third cam/stop release device 338. A mechanical separating stop 362 which functions similar to separating stop 312 previously described with respect to FIG. 18 is connected to third upper track support structure 342.

The offloading of empty cassettes and refilling of the empty cassettes proceeds as follows. Cassette delivery device 218 receives a call signal from loading conveyor 334. The call signal occurs when eighth switch 346 on loading conveyor 334 opens and ninth switch 348 closes. These switch signals indicate that full cassettes of full cassette group 222″ are waiting for pickup on a third upper track assembly 363 of third upper track support structure 342, and that third lower track assembly 361 has space to receive empty cassette group 262′. The call signal is transmitted via the second and fourth optical data devices 248, 336. As cassette delivery device 218 docks or engages with loading conveyor 334, a contact arm 272″ of cassette delivery device 218 engages third cam/stop release device 338 while, simultaneously, a contact arm 272″′ of loading conveyor 334 engages fourth cam/stop release device 340.

At this time second elevator device 360 is positioned in its lower position having no cassette on its loading deck. The tenth switch 350 is closed and the eleventh switch 352 is open. When an empty cassette arrives in the elevator deck of second elevator device 360, eleventh switch 352 closes. An operator (not shown) loads a product 220b onto the empty cassette which closes twelfth switch 354. After a period of approximately 10 seconds following the closing of twelfth switch 354, power unit 260′ energizes and moves the elevator deck to the upper position shown as second elevator device 360a. When the elevator deck reaches the upper position the thirteenth switch 356 closes which de-energizes power unit 260′. The loaded cassette will move by gravity induced motion off the elevator deck onto third upper track assembly 363. When the loaded cassette clears the elevator deck fourteenth switch 358 closes and eleventh switch 352 opens. When fourteenth switch 358 closes and eleventh switch 352 opens, second elevator device 360 reverses operation, power unit 260′ energizes, and second elevator device 360 returns to its lower position to receive a next or subsequent empty cassette.

When second elevator device 360 reaches the lower position, and is in alignment with third lower track assembly 361, the tenth switch 350 closes. When tenth switch 350 closes, power unit 260′ is again de-energized. Second elevator device 360 repeats this cycle of operation until there are no empty cassettes on third lower track assembly 361, or when at a program point a full cassette group 222″ is ready for transfer. With reference again to FIG. 18, the downward pitch or slope of third lower track assembly 361 and third upper track assembly 363 are similar to the slope of second upper track assembly 228 and second lower track assembly 256 such that each has an angle of approximately one degree of downward slope with respect to ground surface 244.

Energy for operation of the conveyor systems of the present disclosure can be provided by battery packs for operation of automatic cart transfer device 238 and by commercial power supply for the various switches and the power units 260, 260′. The guide device 242 of the present disclosure can also take multiple forms including a physical mechanical track that guides the wheels of the automatic cart transfer device 238, or guide device 242 can also be provided as optical tape, or similar forms of data transfer devices that can be read as the automatic cart transfer device 238 travel between the various conveyors. Multiple parallel track assemblies can be configured on both the upper and lower levels of cassette delivery device 218 such that two or more of the full and the empty cassette groups can be carried in parallel at the same time for delivery or receipt by similar multiple parallel track assemblies of the conveyors of the present disclosure.

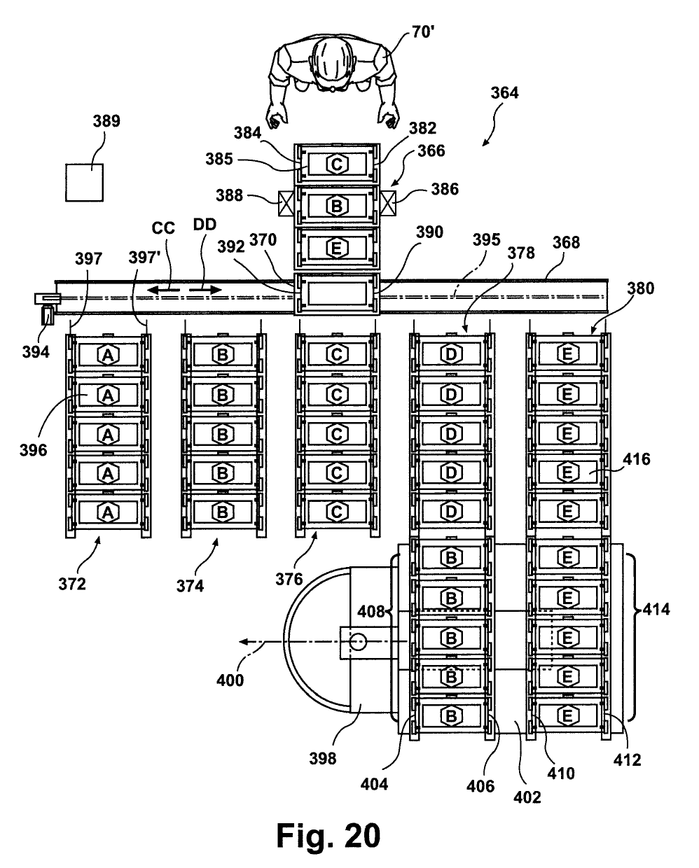

Referring to FIG. 20, a sorting or style selection gravity conveyor system 364 provides the ability to select individual products from a plurality of product groups wherein the individual product groups all have the same product in multiple cassettes that can be reloaded in bulk form. Style selection gravity conveyor system 364 can include a sequence queue 366 which is automatically loaded using a programmed source with individual products that are arranged in sequential need order to support an assembly or production line (not shown). The individual products are selected on a next-in-line basis using a component selection track 368 having a component shuttle cart 370 which is powered for reciprocating travel to select individual products from each of a first, second, third, fourth, or fifth component group 372, 374, 376, 378, 380 gravity conveyors. The quantity of component groups is not limited to the five component groups displayed in FIG. 20 and can vary from two to greater than five component groups depending on the number of individual components used in the production line.

Sequence queue 366 can include a first queue track 382 and a parallel second queue track 384 which are pitched for gravity transfer of the individual product carrying cassettes 385 which have concave perimeter wheels similar to the cassettes previously described herein adapted to roll by gravity induced force on metal rails. In the example shown, three product carrying cassettes 385 are provided with sequence queue 366; however, this quantity can vary from one to greater than three product carrying cassettes 385 at the discretion of the designer. An operator 70′ or robot positioned at a free end of sequence queue 366 offloads each successive product from the product carrying cassettes 385 which have been sequenced in the order necessary to support the production line and are individually identified by a component identifier 386 to verify that each product is the proper product required in the sequence. The sequence of products delivered to sequence queue 366 is controlled by a component sequencer 388 connected to and receiving location and sequencing commands from a computer 389 which direct the component shuttle cart 370 to position itself proximate to one of the first through fifth component groups 372 through 380 to select a next-in-line product and deliver it to sequence queue 366.

Component shuttle cart 370 can include each of a first and second shuttle cart track 390, 392 which in a cart delivery position are downwardly pitched and individually collinearly oriented with one of the first or second queue tracks 382, 384 of sequence queue 366. This allows the cassettes 385 delivered by component shuttle cart 370 to roll off component shuttle cart 370 directly onto first and second queue tracks 382, 384. Stop/release devices similar in function to first and second cam stop/release devices 250, 252 shown and described with respect to FIGS. 15 and 16 can be used on each of the sequence queue 366, the component shuttle cart 370, and each of the first through fifth component groups 372 through 380 to control the release of the individual cassettes. Component shuttle cart 370 is reciprocally moved to individual ones of the first through fifth component groups 372 through 380 by a shuttle drive device 394 which can be driven for example using a shuttle drive belt 395.

Each of the first through fifth component groups 372 through 380 includes a plurality of components 396. In the example shown, first component group 372 includes components “A,” second component group includes components “B,” third component group 376 includes components “C,” fourth group 378 includes components “D,” and fifth component group 380 includes components “E.” Each of the component groups 372 through 380 include downwardly pitched parallel cassette support tracks 397, 397′ which allow gravity movement of the individual cassettes toward component shuttle cart 370. In the example shown, component shuttle cart 370 is capable of moving a single cassette and product from one of the component groups 372 through 380; however, component shuttle cart 370 can also be adapted to carry more than one cassette and product at the same time. As component shuttle cart 370 aligns itself with individual ones of the component groups 372 through 380, the desired number of cassettes and products are offloaded by gravity induced motion onto the component shuttle cart 370.

With reference to both FIGS. 15, 19, and 20, when operator 70′ removes the individual components from sequence queue 366, each now empty cassette can be either automatically or manually moved off sequence queue 366 onto a return cart path provided below sequence queue 366 (not visible in this view), similar to second or third lower track assemblies 256 or 361 of conveyor 219 or loading conveyor 334. When all of the cassettes from an individual one of the component groups have been offloaded, an entire new group of cassettes and products can be reloaded to replace them. This is accomplished using a cassette delivery device 398 which is automatically transported to the proximity of style selection gravity conveyor system 364 using a guidance element 400 positioned on ground surface 244. As shown in FIG. 20, the fifth component group 380 having a plurality of components “E” can be replenished by cassette delivery device 398.

Cassette delivery device 398 can include a cassette track support structure 402 which provides two or more sets of tracks such as first track 404 and a parallel second track 406 which provide a first product group 408 of a plurality of cassettes oriented to gravity offload onto one of the component groups. Similarly, a third track 410 and a parallel fourth track 412 support a second product group 414, which carries a plurality of products “E” for replenishing products 416 of fifth component group 380. As each of the individual product groups are offloaded from cassette delivery device 398, the device is programmed to move to a next one of the component groups to refill that component group. Cassette delivery device 398 can then be moved to a loading conveyor (similar to loading conveyor 334 shown in FIG. 19) to reload the individual product groups that are needed for the next sequence of operations.

Style selection gravity conveyor system 364 provides an advantage of a minimal requirement for power operated components because multiple gravity transferred component groups can be reloaded using downwardly pitched tracks. This reduces the overall power requirements for the conveyor system to that required for the shuttle component cart 370 and the cassette delivery device 398. Because products are delivered to sequence queue 366 on an as-needed basis, when the operator 70′ removes the products and the empty cassettes are removed from sequence queue 366, component shuttle cart 370 only moves to retrieve a next product when sufficient space is provided on sequence queue 366 to accept the new cassette and product. A further advantage of the style selection gravity conveyor system 364 is that products which are delivered in the required sequence for installation are all provided on an automatic system which does not require manual reloading of the component groups or a manual selection by component shuttle cart 370; therefore, human error in selecting the next required component in the sequence of operations is eliminated.

Gravity conveyor systems of the present disclosure offer several advantages. By positioning a metal or plastic band of material within a receiving slot of an extruded member, the rail or band is continuously supported for its entire length, eliminating high and low points that can cause cassette speed discontinuities, providing a smooth operation for the cassettes. By using wheels of a cassette having a concave shape the cassette is retained on the track. By further providing a bracket which includes a retention arm partially extendable into the space provided by the concave surface of the wheels which is oppositely oriented with respect to the track extending portion, the retention arm provides a wheel retention capability to prevent the cassettes from coming off the track until a final destination has been reached. The use of substantially identical extruded bodies of the present disclosure also allows mirror image configurations of the track supporting members which further reduces the overall quantity of components required for a track assembly of the present disclosure.

The foregoing description of the embodiments has been provided for purposes of illustration and description. It is not intended to be exhaustive or to limit the invention. Individual elements or features of a particular embodiment are generally not limited to that particular embodiment but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A gravity conveyor assembly, comprising:
a conveyor including first and second track assemblies oppositely directed with respect to each other, the second track assembly elevated above the second track assembly, and each oriented at a downward pitch angle with respect to a ground surface;
a cassette delivery device releasably engageable to the conveyor, including:
an upper track portion providing for gravity induced rolling motion of a cassette, the upper track portion collinearly aligned with the second track assembly so that the cassette on the upper track portion rolls onto the second track assembly when a first retention device is displaced during engagement of the cassette delivery device to the conveyor; and
a lower track portion providing for gravity induced rolling motion of the cassette and collinearly aligned with the first track assembly so that the cassette when positioned on the second track assembly moves by gravity induced motion onto the lower track portion when a second retention device is displaced during engagement of the cassette delivery device.

2. The gravity conveyor assembly of claim 1, wherein the first and second retention devices each comprise:
an assembly connected to one of the cassette delivery device upper track portion or a support member of the second track assembly, having:
a release pin normally biased to an upwardly extended position restraining cassette motion; and
a contact wheel operating when displaced to retract the release pin from the upwardly extended position permitting cassette motion.

3. The gravity conveyor assembly of claim 2, wherein the first and second retention devices each further comprise a contact arm connected to the other one of the cassette delivery device upper track portion or the support member of the second track assembly, including an arm portion having a contact surface defining an angle with respect to the ground surface; wherein the contact wheel is displaced by contact with the contact surface when the cassette delivery device engages with the conveyor, the release pin returning to the upwardly extended position when the cassette delivery device disengages from the conveyor.

4. The gravity conveyor assembly of claim 1, wherein the cassette supports a product carried to a temporary stop position on the second track assembly, the cassette after removal of the product defining an empty cassette.

5. The gravity conveyor assembly of claim 4, further including an elevator device operating to receive the empty cassette and move the empty cassette downward to align concave perimeter wheels of the empty cassette with the first track assembly for gravity return of the empty cassette to an empty cassette group.

6. The gravity conveyor assembly of claim 5, further comprising:
an elevator device operating to receive the cassette and move the cassette downward from the second track assembly to align concave perimeter wheels of the cassette with the first track assembly;
a power unit driving the elevator device;
a first switch signaling the power unit to energize when the cassette reaches the elevator device; and
a second switch signaling the power unit to return to the second track assembly when the cassette rolls by gravity away from the elevator device onto the first track assembly.

7. The gravity conveyor assembly of claim 1, wherein the cassette includes at least first and second wheels each having a concave perimeter surface positioned between an inner perimeter edge and an outer perimeter edge.

8. The gravity conveyor assembly of claim 1, wherein the second track assembly is positioned entirely above the first track assembly

9. The gravity conveyor assembly of claim 1, wherein:
the cassette includes at least first and second wheels individually mounted to opposed sides of the cassette;
each of the wheels having a concave perimeter surface positioned between an inner perimeter edge and an outer perimeter edge; and
the track assemblies and the upper and lower track portions each include parallel metal strips in contact with the concave perimeter surface of individual ones of the first and second wheels during cassette movement.

10. The gravity conveyor assembly of claim 1, further including a rocking stop/release member connected to an upper track support structure of the second track assembly, including first and second stop legs rotatable about a pivot axis, the first stop leg contacting the cassette to temporarily restrain motion of the cassette, and the second stop leg rotating to contact a second cassette as the first stop leg rotates with respect to the pivot axis to release the cassette.

11. The gravity conveyor assembly of claim 1, wherein the downward pitch angle is approximately one degree.

12. A gravity conveyor assembly, comprising:
a conveyor including first and second track assemblies oppositely directed with respect to each other, the second track assembly elevated above the second track assembly, and each oriented at a downward pitch angle with respect to a ground surface;
a cassette delivery device releasably engageable to the conveyor, including:
an upper track portion providing for gravity induced rolling motion of a cassette, the upper track portion collinearly aligned with the second track assembly so that the cassette on the upper track portion rolls onto the second track assembly when a first retention device is displaced during engagement of the cassette delivery device to the conveyor; and
a first optical data device connected to the conveyor and a second optical data device connected to the cassette delivery device, the first and second optical data devices wirelessly transferring data to and from each other to identify when space to receive the cassette is available on the conveyor.

13. The gravity conveyor assembly of claim 12, wherein the cassette delivery device further includes a lower track portion providing for gravity induced rolling motion of the cassette and collinearly aligned with the first track assembly so that the cassette when positioned on the second track assembly moves by gravity induced motion onto the lower track portion when a second retention device is displaced during engagement of the cassette delivery device.

14. The gravity conveyor assembly of claim 13, wherein the first and second retention devices each comprise:
an assembly connected to one of the cassette delivery device upper track portion or a support member of the second track assembly, having:
a release pin normally biased to an upwardly extended position restraining cassette motion;
a contact wheel operating when displaced to retract the release pin from the upwardly extended position permitting cassette motion; and
a contact arm connected to the other one of the cassette delivery device upper track portion or a support member of the second track assembly, the contact wheel displacing by contact with the contact arm when the cassette delivery device engages with the conveyor, the release pin returning to the upwardly extended position when the cassette delivery device disengages from the conveyor.

15. The gravity conveyor assembly of claim 14, wherein the contact arm includes a contact surface defining an angle with respect to the ground surface.

16. The gravity conveyor assembly of claim 13, further including:
a separating stop link slidably connected to the first track assembly; and
a stop arm connected to the first track assembly and rotatably positioned to an upright position by displacement of the separating stop link when the second retention device is engaged, the stop arm in the upright position contacting the cassette to prevent rolling movement of the cassette toward the lower track portion.

17. The gravity conveyor assembly of claim 13, further including a first anti-backup latching device connected proximate to a cassette receiving end of the lower track portion, and a second anti-backup latching device connected proximate to a cassette receiving end of the upper track portion, the first and second anti-backup latching devices including a cam arm rotatable about a cam axis, the cam arm gravity rotatable to an upright position by a cam return mass after contact with the cassette.

18. The gravity conveyor assembly of claim 13, wherein the cassette includes:
at least first and second wheels individually mounted to opposed sides of the cassette; and
each of the wheels having a concave perimeter surface positioned between an inner perimeter edge and an outer perimeter edge, the concave perimeter surface of each of the wheels aligned for rolling contact with a metal rail of individual ones of the first and second track assemblies and the upper and lower track portions of the cassette delivery device.

19. The gravity conveyor assembly of claim 12, further comprising a first switch mounted on the second track assembly of the conveyor, the first switch generating a signal indicating the space for the cassette is open on the conveyor.

20. The gravity conveyor assembly of claim 19, further comprising a second switch mounted on the first track assembly of the conveyor, the second switch generating a signal indicating presence of the cassette on the first track assembly.

21. A gravity conveyor system, comprising:
a sequence queue having parallel first and second queue tracks both having a downward pitch with respect to a ground surface;
a component selection track having a component shuttle cart powered to multiple cassette receiving positions;
component group gravity conveyors individually oriented transverse to the component selection track and individually aligned with individual ones of the cassette receiving positions of the component selection track;
wheeled cassettes each carrying a component grouped on downwardly pitched tracks of the component group conveyors for gravity induced motion toward the component selection track; and
a component sequencer directing the component shuttle cart to individual ones of the cassette receiving positions to receive by gravity induced motion one of the wheeled cassettes for transport of the component carried by the one of the wheeled cassettes to the sequence queue.

22. The gravity conveyor system of claim 21, further including a component identifier signaling a correctly received next-in-sequence cassette and product.

23. The gravity conveyor system of claim 21, further including a shuttle drive device for bi-directional displacement of the component shuttle cart.

24. The gravity conveyor system of claim 21, wherein different components are carried on the wheeled cassettes of different ones of each the component group gravity conveyors.

25. The gravity conveyor system of claim 21, further including:
a movable cassette delivery device having a cassette track support bed, the bed including:
parallel downwardly pitched first and second tracks carrying cassettes supporting a first component type for gravity refilling one of the component group gravity conveyors; and
parallel downwardly pitched third and fourth tracks carrying cassettes supporting a second component type for gravity refilling a second one of the component group gravity conveyors.
